(19) United States
(12) Patent Application Publication
(10) Pub. No.: US 2018/0151162 A1
(43) Pub. Date: May 31, 2018

(54) Effects pedal board with integrated multi effects switcher

(71) Applicant: Alan Richard McKenzie, Anaheim, CA (US)

(72) Inventor: Alan Richard McKenzie, Anaheim, CA (US)

(21) Appl. No.: 15/818,726

(22) Filed: Nov. 20, 2017

Related U.S. Application Data
(63) Continuation-in-part of application No. 62/497,558, filed on Nov. 21, 2016.

(51) Int. Cl. G10H 1/34

(52) U.S. Cl. CPC G10H 1/348; G10H 2210/155

(57) ABSTRACT

A guitar effects pedal board with a multi effects switcher pcb assembly or assemblies encased in an effects pedal board which can activate or deactivate single or groups of multiple effects pedals which are set on top or mounted to the top of an effects pedal board. What is novel about this invention is that the multi effects switcher pcb assembly or pcb assemblies are integrated into the pedal board sheet metal and is not a separate product attached the pedal board. This design lends itself to a more cost effective solution for the consumer with easier initial setup when mounting and connecting cables between the multi effects switcher connections and the effects pedals connections, resulting in a more organized effects pedal board cable management system by minimizing cable cross over, audible noise and tone loss.

### CROSS REFERENCE TO RELATED APPLICATIONS

This application claims the benefit of applicant's prior provisional patent application 62/497,558

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not Applicable

### STATEMENT REGARDING PRIOR DISCLOSURES BY THE INVENTOR OR A JOINT INVENTOR

Not Applicable

### SEQUENCE LISTING

Not Applicable

### BACKGROUND OF THE INVENTION

### Field of the Invention

This invention relates to the field of music accessories. More specifically this invention relates to the area of guitar and bass effects pedal boards.

### Description of Related Art

Effects pedal board: An effects pedal board apparatus for the purpose of this related art; supports several types and quantities of apparatuses that can be activated when a user utilizes a stringed instrument that requires amplification such as a guitar. Such apparatuses commonly are known as effects pedals, multi effects switchers and tuners along with other useful types apparatuses utilized by user's which are set or affixed to the top of the pedal board then connected together with cables so there can be electrical continuity from the instrument, through the apparatuses on the pedal board and into an amplifier to amplify the signal.

Many guitar players for example prefer to choose from a selection of manufactures product on the market to build their own unique tone through a unique effects pedal board set up they create from the different manufactures product on the market, instead of utilizing a type of pedal board that is designed to enclose all the effects encased on the inside of the pedal board sheet metal. Often consisting of one main board PCB assembly and possibly a few daughter board pcb assemblies, to contain the electrical circuitry for all effects that, that particular manufacturer chooses to include in that particular pedal board design. There by limiting the individual to the available effects and tone combinations to that manufacturer's effects pedal board design.

Effects pedals: Being defined as a separate apparatus. These are typically individually powered apparatuses through the use of a battery or power supply. With connection points on any side or top surface of the effects pedal, such as a power jack which applies power to the effects pedal and one or more of each “in” and “out” jacks to carry the signal through the effects pedal. Depending on the particular effects pedals electrical design, effects pedals can provide individual or combined audio effects such as reverb, delay, chorus and numerous other audio effects used by guitars and bass or other stringed instrument players. Effects pedals can be used individually or in combination with other individually encased effects or other useful apparatuses with or without the use of an effects pedal board.

A multi effects switcher is an apparatus designed to activate multiple effects pedals and other apparatuses by connecting several separate effects pedals and other apparatuses to a multi effects switcher. Connections between the multi effects switcher and apparatuses setting or affixed to the top of the pedal board is typically accomplished by plugging a cable into the “send” or “out” (other terms may be used) connection of a multi effects switcher unit, then connecting the other end of that cable into the “in” (other terms may be used) side of an effects pedal or similar apparatus. Then plugging a separate cable into the “out” (other terms may be used) side of an effects pedal to the “return” or “in” (other terms may be used) of the multi effects switcher. Then, repeating the process for each apparatus that is on the pedal board. The main purpose of a multi effects switcher is to handle multiple effects switching functions and amp switching functions with minimal effort.

A power supply is a device that powers effects pedals and other devices through the power supplies out puts. The power supply is mounted underneath or on top of a pedal board using several different mounting methods.

The previous described related art apparatuses are normally intended to be placed on top of a pedal board designed for this purpose and operated individually as the separate units they are, or in combination with other guitar or bass effects pedals. Or by the aid of a multi effects switcher (other common names of this device are “effects switcher”, “switcher/looper” or “pedal controller”), herein after will be called “multi effects switcher”.

### BRIEF SUMMARY OF THE INVENTION

This pedal board with integrated multi effects switcher invention has been invented to solve certain issues related to mounting and setting up a multi effects switcher to an effects pedal board. The utility of this design creates an overall compact solution for how musicians use individual guitar effects pedals that set or are affixed to the top of guitar pedal boards. The practical advantages and functional uniqueness of this design has been affirmed within its own industry. This product was recognized at “The NAMM Show 2016” trade show “Best of Awards” and was awarded the “Gotta Stock It” award on Jan. 24 2016.

Integrating a multi effects switchers “printed circuit board or printed circuit boards”, assembly or assemblies underneath a pedal board and designing this apparatus as one product, is a new and revolutionary design in effects pedal boards which use individual effects pedals and similar useful apparatuses typically used on top of effects pedal boards by the user. Incasing the switcher assembly under the pedal board within the pedal board's sheet metal keeps cable routing and cable lengths to a minimum. This design also simplifies cable routing and overall setup of the pedal board. This method also creates more usable top surface space for effects pedals to be mounting and adds convenience for carrying and transporting for the user. Also through shorter and more direct cable routing this design can help reduce audible noise injected into cables and tone loss which occurs more as cables lengths build up.

### BRIEF DESCRIPTION OF THE SEVERAL VIEWS OF THE DRAWINGS

FIG. 1; 3D drawing view of invented effects pedal board with integrated multi effects switcher showing that the pedal board and multi effects switcher as one apparatus are inseparable from the multi effects switcher.

Item 1 points to the complete effects pedal board with integrated multi effects switcher.

FIG. 2; 2D drawing side view with cut out section of invented pedal board sheet metal encasing the multi effects switcher pcb assembly.

Item 2 showing the multi effects switcher pcb assembly integrated into the pedal board sheet metal and not as a separately encased multi effects switcher apparatus, leaving the multi effects switcher inseparable as a separate product.
Item 3 showing the path of cables with the invented design, which requires the path of cables to either route, to or from, the multi effects switcher with the need to only pass through one surface or plane of the pedal board.
Item 4 showing the dual purpose pedal board support bracket/multi effects switcher pcb assembly support bracket.

FIG. 3; 2D drawing bottom view of invented feed through cabling example with the need to only feed each individual cable from the bottom of the pedal board to the top of the pedal board or top of the pedal board to the bottom of the pedal board passing through only one surface or plane of the pedal board to connect the multi effects switcher to the effects pedals or other useful pedal board apparatuses. The design of the pedal board cable cutouts can be any appropriate size or shape cut out or cutouts for the cable to pass through.

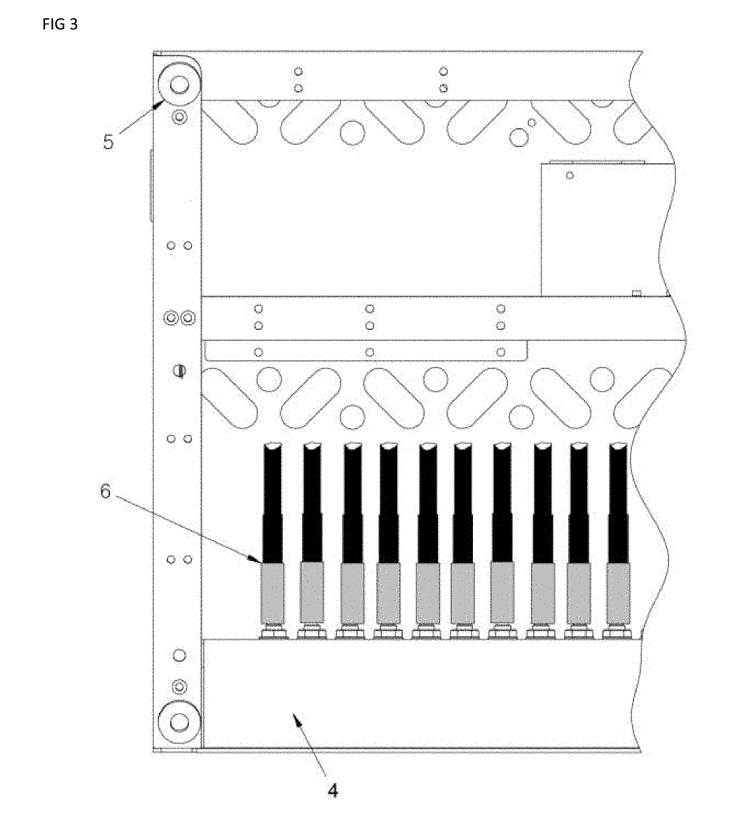

FIG. 4; 2D drawing top view of invented feed through cabling example with the need to only feed each individual cable from the bottom of the pedal board to the top of the pedal board or top of the pedal board to the bottom of the pedal board passing through only one surface or plane of the pedal board to connect the multi effects switcher to the effects pedals or other useful pedal board apparatuses.

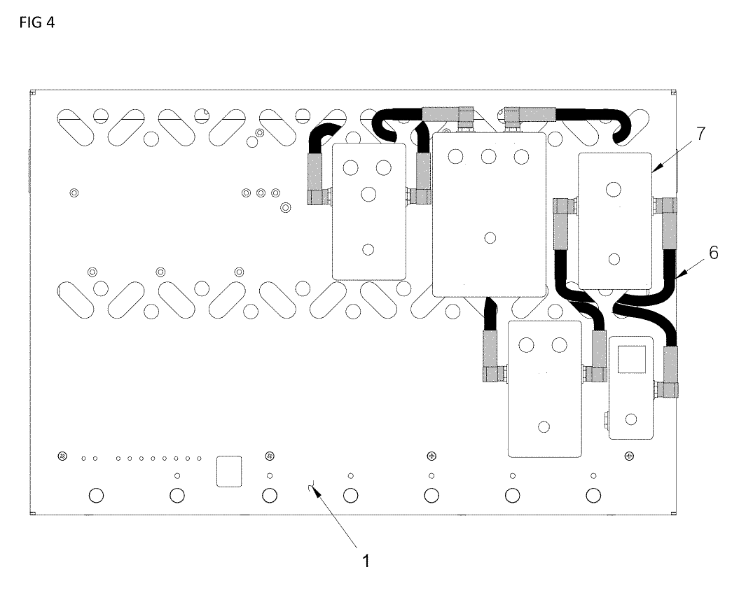

### DETAILED DESCRIPTION OF THE INVENTION

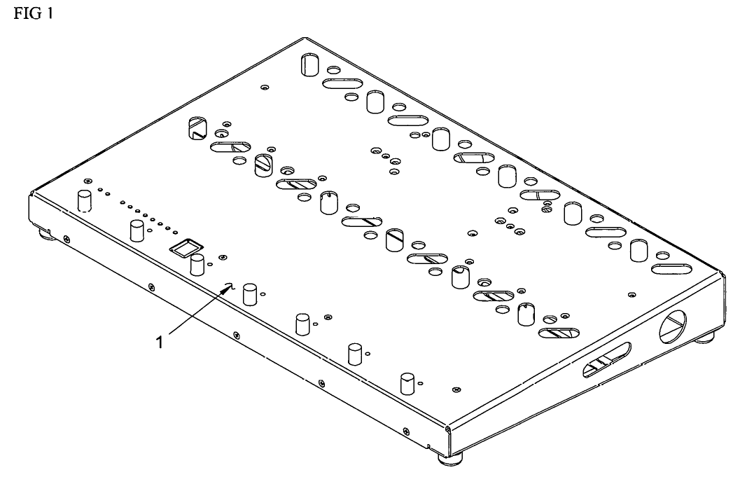

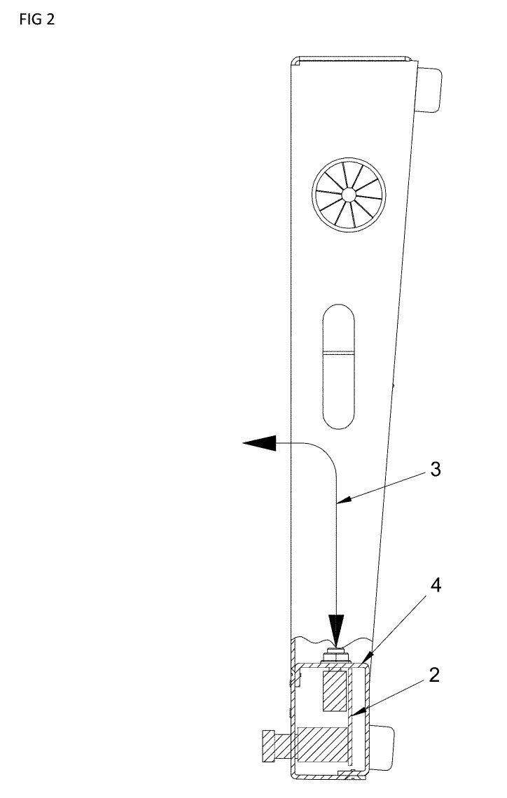

This invention is an effects pedal board designed with an integrated multi effects switcher. Encasing the multi effects switcher “printed circuit board or printed circuit boards”, herein after referred to as “pcb or pcb's” assembly or assemblies, within the effects pedal board sheet metal or any other appropriate material for encasing an electronic enclosure, resulting in the multi effects switcher being an inseparable product from the effects pedal board. Not a multi effects switcher apparatus encased in its own material as a separate product then attached to an effects pedal board (FIG. 1, 2, 3, 4). Wherein the improvement comprises of and solves several problems with mounting a multi effects switcher to the top or any side of a pedal board, referring to pedal board designs which are designed to place effects pedals on the top of a pedal board. The primary invented features of this invention is that the integrated multi effects switcher pcb assembly mounts underneath the pedal board incased in the pedal board sheet metal, with the proper cutouts in the main body of the top of the pedal board for necessary foot switches, LED's, LCD displays and other switcher component parts that are related to user interface and functionality of a multi effects switcher (FIG. 1, 2, 4). This design easily allows for routing cables directly from the multi effects switcher to effects pedals either from bottom to top routing or top to bottom routing through the pedal board surface one time for each cable to make connections simple with minimal routing and cross over cabling required (FIG. 2, 3, 4).

Another core benefit of having the multi effects switcher integrated in the pedal board sheet metal, underneath the pedal board top surface, is this mounting method allows for more pedal board space to place effects pedals within the given size of that particular model. Where normally a switcher and protruding cable connectors attached to cables would occupy approximately 3″ to 10″ of space on top of pedal board or occupy approximately 3″ to 10″ of space inches in front of a pedal board depending on the multi effects switcher manufacturer and instrument cable manufacturers design.

This design allows for a straightforward hook up of more economical standard grade (thicker) cables, to simply route cables from the bottom to the top or top to bottom (FIG. 2, 3, 4), however more expensive “thinner” cables with more compact connector designs can still be used.

Having the multi effects switcher integrated underneath the pedal board allows for a more organized cable management system, faster cable hook up and faster over all pedal board set up (FIG. 2, 3, 4), eliminating the need to purchase compact higher price cables. Many of these higher priced cables with smaller compact connectors on each end of the cable are a solder-less design. Which have a reputation to be less reliable due to their inherent deficiencies in a solder-less cable design compared to manufactures soldered cable designs.

### Modularity:

This effects pedal board with its integrated switcher is setup to allow for mechanical and electrical modularity, so the user can connect extension modules that allow for further expansion of their pedal board set up.

### Summary of Improvements Over Current Designs:

This design saves space by integrating the multi effects switcher assembly under the effects pedal board. This allows for more surface area to mount more effect's pedals and similar useful effects pedal board apparatuses on the top side of the pedal board (FIG. 1, 2, 3, 4). There is no need to mount a multi effects switcher as a separate apparatus with this design. Mounting a multi effects switcher as a separate apparatus takes up valuable effects pedal board space either on top of the effects pedal board or in front or surrounding area of an effects pedal board. Easier cable hook up with shorter cable lengths is achieved with this design, improved hookup time, cleaner and more simplified cable routing, which in turn results in simplified troubleshooting of cable hookup issues and reduction of audible noise related to EMI and RFI emissions. A shorter cable routing path from a multi effects switcher mounted underneath a pedal board to the guitar effects pedals or similar useful apparatuses mounting to the top of an effects pedal board results in a more organized effects pedal board cable management system by minimizing cable cross over, audible noise and tone loss. Integrating a multi effects switcher into the effects pedal board has a cost savings benefit by reducing material cost to encase both and effects pedal board and a multi effects switcher separately.

1: Specific and unique pedal board with integrated multi effects switcher combined as one inseparable unit in one design.

2: Specific and unique cable routing resulting from this effects pedal board design with an integrated switcher that simplifies cable routing from top to bottom or bottom to top of pedal board.

3: Specific and unique pedal board with integrated multi effects switcher according to claim 1, whereas; space saving resulting from the method described of integrating the multi effects switcher pcb assembly into an effects pedal board.

4: Specific and unique pedal board with integrated multi effects switcher according to claim 1, whereas; design of locating an effects multi effects switcher underneath the top surface of a pedal board.

5: Specific and unique pedal board with integrated multi effects switcher according to claim 2, whereas; cost savings when using standard grade instrument cables with this design and not requiring the more expensive space saving cable designs.

6: Specific and unique pedal board with integrated multi effects switcher according to claim 1, whereas; cost savings when integrating an effects pedal board and switcher into one product.

7: Specific and unique pedal board with integrated multi effects switcher according to claim 2, whereas; cable management system, when integrating a multi effects switcher assembly under an effects pedal board resulting in shorter and more organized cabling.

8: Specific and unique pedal board with integrated multi effects switcher according to claim 1, whereas; simplified set up time for an effects pedal board, that utilizes a multi effects switcher apparatus.

9: Specific and unique pedal board with integrated multi effects switcher according to claim 2, whereas; cable management through shorter and more direct cable routing helping to reduce EMI and RFI emissions and tone loss which occurs more as cables cross each other and cable lengths build up.

10: Specific and unique mechanical and electrical modularity, so a user can join two pedal boards with multi effects switchers through mechanical and electrical connections connect extension modules that allow for further expansion of pedal board set up.
